(19) United States
(12) Patent Application Publication
(10) Pub. No.: US 2014/0284201 A1
(43) Pub. Date: Sep. 25, 2014

(54) SOLAR POWERED CONCENTRATION UNIT AND METHOD OF USING SOLAR POWER TO CONCENTRATE A SUBSTANCE

(71) Applicants: Lincoln G. Remmert, Marengo, OH (US); Shane S. Walton, East Heath, OH (US)

(72) Inventors: Lincoln G. Remmert, Marengo, OH (US); Shane S. Walton, East Heath, OH (US)

(73) Assignee: Battelle Memorial Institute, Columbus, OH (US)

(21) Appl. No.: 14/216,754

(22) Filed: Mar. 17, 2014

Related U.S. Application Data
(60) Provisional application No. 61/798,297, filed on Mar. 15, 2013.

(51) Int. Cl. B01D 3/00

(52) U.S. Cl. CPC B01D 3/00
USPC 203/22; 202/234

(57) ABSTRACT

A solar-powered concentration unit and method of conducting a solar powered separation are described. An improved method of solar-powered concentration of ethylene glycol is described and exemplified. The invention also includes a mobile distillation/concentration unit that can be placed on a truck and transported to a desired location. A further advantage of the invention is that good separations can be achieved without the use of a selective membrane and/or mechanical pumps.

### RELATED APPLICATIONS

This application claims the benefit of U.S. Provisional Patent Application No. 61/798,297, file Mar. 15, 2013.

### INTRODUCTION

The use of solar power to drive distillation processes could be environmentally advantageous; however, there remain technical and environmental challenges that have limited the application of solar power to distillation processes. The present invention provides improvements in the apparatus and methods of solar-powered distillation processes.

If technical and economic barriers can be overcome, a possible use of solar-powered distillation is in the reclamation of ethylene glycol. Ethylene glycol is often used in conjunction with water to create antifreeze. Antifreeze is used in the cooling systems of internal combustion engines to ensure that damage is not caused by the coolant freezing during cold seasons. Ethylene glycol has a low freezing point which allows solutions to withstand very cold temperatures without freezing. It also has a high boiling point of 387° F.

In some states, ethylene glycol is considered hazardous waste and must be disposed of as such. If ingested, ethylene glycol can be toxic to both humans and animals as it attacks the central nervous system. It has a sweet, syrup-like texture that attracts animals and small children which makes it more dangerous.

Ethylene glycol does not typically break down while in use, so it can be continually recycled so long as it is not highly contaminated with heavy metals or oils. Recycling or reusing ethylene glycol has many advantages. The first benefit is that it would be cost effective. The cost of antifreeze is around $11/gallon and if reused this cost would be eliminated. Disposal of hazardous waste, such as used antifreeze, can be very costly as it will need to be stored and transported to a facility that can do so.

Recycling ethylene glycol would also help United States federal facilities meet the goals set forth by Executive Orders 12856, 12873, 13101, and 13148. Department of Defense Pollution Prevention Instructions require that federal facilities reduce waste coming from any federal facility. Recycling and reusing antifreeze would reduce the overall waste stream and would also reduce the amount of new antifreeze that would need to be purchased. In addition, some regulatory relief may be recognized during the life cycle management of the antifreeze if it is generated, recycled and reused at the same facility.

Several examples of apparatus for recycling ethylene glycol are described in the patent literature. F. example, Eastcott et al., in U.S. Pat. No. 5,535,877 describe a method and apparatus for removing water from a solution of water and glycol solution. The purpose of the invention is primarily for recovering ethylene glycol used at airports for wing deicing. Eastcott et al. remarked that the success of their process “depends upon a thin film evaporation process.” This is accomplished by passing air through an evaporation tank containing a packing medium such as crushed glass, An air stream passes upwards through the packing medium to help sweep water vapor away from the ethylene glycol. A pump enhances removal of water vapor. Eastcott et al, envisage the system being able to operate without a heat source; however the inventors also contemplated operating their concentrator with a transparent roof so that solar energy would enhance their process.

Radhakrishnan et al. in U.S. Pat. No. 7,713,319 proposed a process of recovering ethylene glycol by passing a stream of aqueous ethylene glycol by a glycol-selective membrane. The aqueous effluent may then pass to a thermal distiller that removes at least a portion of the residual glycol from the effluent stream using heat. Radhakrishnan et al. suggest that a renewable energy source, such as a solar thermal energy source (among numerous other possibilities), generates the heat. The thermal distiller employs fractionation to separate the residual glycol from the second effluent stream and discharges the separated glycol in a third effluent stream to a storage reservoir. Radhakrishnan et al. do not provide any description of the construction of the thermal distiller.

Garcia et al. in United States Published Patent Application 20070193872 describe a solar heating, distilling, and pasteurizing system that comprises an integrated distillation column-reflector-bracket assembly, a heat storage system, and at least one evacuated glass solar collector. A distillation column subassembly is filled with the fluid medium to be boiled which flows into the solar vacuum tube collectors where an evaporation process takes place. A float valve mechanism mounted to the frame automatically maintains the correct liquid level inside the distillation column. A distillation column subassembly collects and concentrates the steam or vapor generated inside the attached evacuated glass solar collector tubes. The column also separates the vapor from the boiling liquid medium and conducts the vapor into a heat and distilled fluid storage system. The reflector-bracket subassembly has a reflecting panel made from at least one sheet of reflective material typically flat or formed into a plurality of substantially parallel linear troughs shaped to concentrate solar radiation ideally.

### DESCRIPTION OF THE INVENTION

In a first aspect, the invention provides a method of separating components in a solar-powered unit, comprising: providing a solar-powered distillation unit comprising: a storage chamber, a solar thermal collector array, and piping that forms a circuit from the storage chamber past and in thermal contact with the solar thermal collector array, and back to the storage chamber; and providing to the storage chamber a liquid solution comprising a first component and a second component wherein the first component has a boiling point that is lower than the boiling point of the second component. During operation, the solar thermal collector array collects heats from the sun and a portion of the liquid solution passes from the storage chamber through the piping past and in thermal contact with the solar thermal collector array where heat is transferred from the solar thermal collector array to the liquid solution to form a heated solution. A vapor is formed from the heated solution and at least a portion of the vapor passes out of the circuit. The vapor that passes out of the circuit has a higher ratio of the first component to the second component than the liquid that remains in the storage chamber. Liquid from the heated solution is returned to the storage chamber.

A storage chamber means any type of container that can hold a liquid solution. Preferably, the storage chamber is insulated to maintain heat of the solution. In some embodiments, the storage chamber is open to the atmosphere so that the lower boiling component can escape into the atmosphere. In other embodiments, the chamber can be closed to the atmosphere and a vapor exiting the storage chamber passes through a separation column (for example, a fractionating column) to further improve the separation of the first and second components. The storage chamber may also be called a distillation chamber.

A solar thermal collector array is an array of solar collectors. An array comprises at least 2 collectors, preferably at least 5, and in some embodiments in the range of 10 to 50. Additional heating can be obtained by using more than one array in series. A preferred type of thermal collectors comprise insulating, evaporated glass tubes having a solar-radiation absorbent layer on the inside of the tubes and a heat transfer medium for transferring heat from the interior of the tubes to an end of the tubes. For example, the heat transfer medium can be water that condenses in a copper tube at one end of the tubes, or simply a metal fin. The circuit is arranged so that the solution passes in thermal contact with an end of the tubes in the array and heat is transferred from the tubes to the solution. For example, the solution can be carried in a copper pipe across the tops of the tubes in the array where heat is transferred from the tubes to the solution.

The vapor can form from the solution as the solution passes through the circuit. As an alternative, or in addition to vapor formation as the solution passes in contact with the thermal array, the heated solution can return into the storage chamber and vaporize inside the storage chamber. In some preferred embodiments, the solution carries sufficient heat from the thermal array so that the solution in the storage chamber is at or above the boiling point of the first component, or at or above the azeotrope of the first and second components (if one exists).

A circuit is the pathway in the inventive apparatus through which the solution passes from the storage chamber past the solar thermal array and back to the storage chamber.

The invention is generally applicable to any mixture of components that have differing boiling points. Preferred examples are ethylene glycol/water, propylene glycol/water, ethylene and propylene glycol/water, and water contaminated with fuel. An especially preferred system is water and ethylene glycol.

In a preferred embodiment, at least a portion of the vapor exiting the circuit is condensed inside a secondary storage tank holding a liquid solution that is to be subsequently processed. For example, a secondary storage tank would contain a heat exchange coil where steam (or other vapor) would pass through and re-condense on its way to exiting the system. This preheated solution could be, for example, a weak antifreeze solution that is destined to be processed by the system on the following day. The pre-heated solution could be started out at a higher initial temperature on the following day to allow for a shorter time from startup to initial boiling temperature which should enhance the concentration process. In some aspects, the storage chamber further comprises a heat exchanger in thermal contact with the liquid solution and wherein a portion of the heat from the liquid solution is used is preheat a solution in a preheat chamber to form a heated solution.

In some particularly preferred aspects of the invention, thermal siphoning is utilized to cause at least a portion of the liquid solution to flow through the piping. Preferably, pumping is not used to force solution through the circuit. This provides a significant advantage over pumping since the apparatus is simpler and because an external power source isn't required. It was additionally discovered that the system utilizing thermosiphoning operated better than with pumping; this may occur because the thermosiphoning is self-correcting and adjusts the flow rate according to environmental conditions. In some preferred embodiments, the storage chamber is positioned above the ground, in some embodiments positioned, with respect to gravity, above the solar array.

In some aspects, there is a condenser disposed in the circuit between the solar array and the storage chamber wherein liquid forms in the condenser and the liquid formed in the condenser is returned to the storage chamber. In some aspects, there is a fractionating column for vapor exiting the circuit to increase the separation of components (i.e., reduce the fraction of the higher boiling component leaving the system). In some preferred embodiments, the fractionating column has hydrophobic surfaces.

In some aspects, the storage/distillation chamber further comprises a spray nozzle that sprays a solution comprising the first and second components. This will increase the surface area of the liquid yielding additional opportunity to separate water and ethylene glycol.

The invention also provides a method of operating a solar-powered distillation unit, wherein the unit comprises: a distillation chamber for holding a solution; a series of solar thermal collector arrays; at least one pump disposed between the distillation chamber and the series of solar thermal collector arrays. This method includes transferring heat to the solution, returning the solution to the distillation chamber via piping, recycling the solution through the distillation chamber and arrays, and raising the temperature of the solution to the boiling point of at least one component of the solution.

In some preferred embodiments of the invention, the storage/distillation chamber is fitted with two pressure relief valves, and has four openings in the top of the tank; one that serves as a port for influent returning from the n-solar thermal collector panels, two to allow steam to escape for evaporation purposes and one for filling chamber with more solution when needed. In another embodiment, the storage/distillation chamber is fitted with two pressure relief valves, and has four openings in the top of the tank; one that serves as a port for influent returning from the n-solar thermal collector panels, two to allow steam to escape for evaporation purposes and one for filling chamber with more solution. Vacuum can be applied to the two openings for the lower boiling component (such as steam). Temperature sensors can be located before and after each solar thermal collector array and, optionally, at two levels of the distillation chamber, to measure the temperature of the solution as it flows through system. In some preferred embodiments, a valve is located after the final solar thermal collector array to allow draining of the system and sampling to determine the concentration of the ethylene glycol solution. A valve can be located before the first solar thermal collector array to allow draining of the system.

In some preferred aspects, the solar thermal collector array(s) are mounted on a solar tracking device.

The inventive method is capable of rapid heating of the liquid solution. In some preferred embodiments, the temperature of the solution in the storage/distillation tank is raised at a rate of at least 0.5 degrees Fahrenheit per minute, or at least 0.75 degrees Fahrenheit per minute, or at a rate of at least 1.0 degrees Fahrenheit per minute.

In a particularly preferred embodiment, recycled ethylene glycol/water having a concentration of less than 37% ethylene glycol is periodically transferred to the distillation chamber.

The invention also includes the corresponding distillation unit and/or a system that includes the apparatus and fluids within the apparatus (and, optionally, may also include specified conditions of the fluids). The invention also includes a kit that includes components of the unit; the kit is transportable. For example, another aspect of the invention provides a kit comprising: a distillation chamber, a solar thermal collector array, and piping; wherein the distillation chamber, the solar thermal collector array, the piping are adapted to form a circuit from the distillation chamber past and in thermal contact with the solar thermal collector array, and back to the distillation chamber. In preferred aspects, the kit includes a preheat chamber and a heat exchanger that are adapted to transfer heat from a liquid solution in the distillation chamber to a liquid in the preheat chamber.

### BRIEF DESCRIPTION OF THE DRAWINGS

FIG. 1 shows a schematic drawing of a solar concentration unit similar to the Solar Powered Ethylene Glycol Concentration Unit that was operated as described in the Examples.

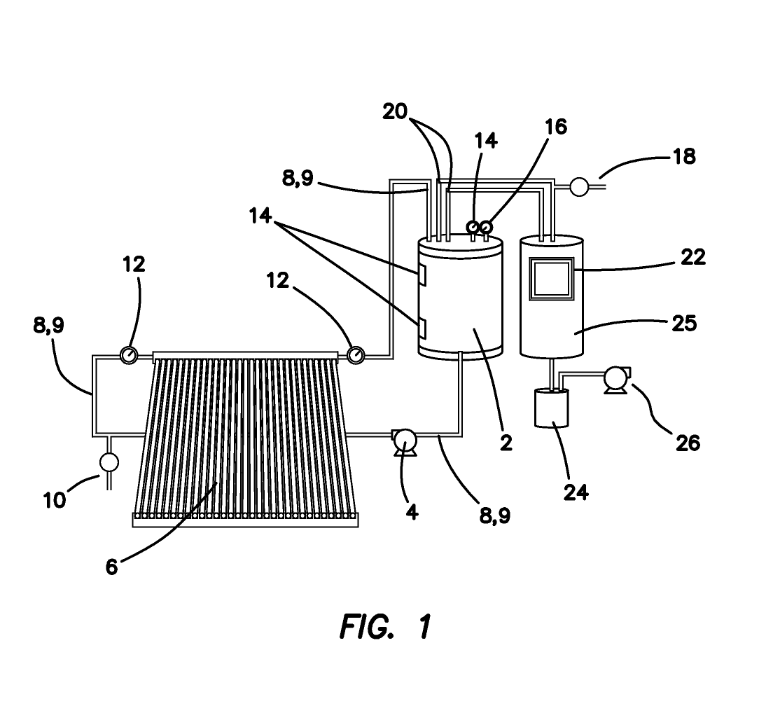

An embodiment of the invention is illustrated in FIG. 1. A solution to be separated is transferred into the storage/distillation chamber 2. The solution is moved by a pump 4 or carried by thermosiphoning into one or more solar arrays 6 where the solution absorbs heat, and the resulting heated solution flows into an insulated vessel (storage/distillation chamber 2). The solution is recycled (in some preferred embodiments, continuously recycled) through the solar array(s). The volatile fraction(s) (water steam in the case of an aqueous ethylene glycol solution) is removed as a vapor from the system (for example where the insulated vessel is open to the atmosphere) or released through pressure release valves 18 (steam or condensation discharge lines), or passed through a fractionating column 20, or through discharge lines under vacuum. The system includes piping 8 that forms a conduit between the solar array and the storage tank forming fluid circuit 9. The illustrated system also shows a variety of components that were present in the tested apparatus but may not be needed in apparatus in the field include sampling port 10, temperature gauges 12, 15, sampling ports 14, pressure gauge 16, and pressure relief valve 18. The vaporized component can be cooled by cooling loop (heat exchanger) 22 in container 25, and, if desired, condensate can be collected in tank 24, and, optionally may be moved through the condensate collection system with the aid of vacuum pump 26.

Suitable solar arrays are commercially available. An advantage of the present invention is that the components can be easily assembled and disassembled for easy transport and/or sizing of the system for separation of the desired quantity of fluid. For recycling ethylene glycol, it is preferred that an aqueous solution having 5 to 20 wt % solution be converted to a solution containing at least 37%, more preferably at least 50 wt % ethylene glycol.

### EXAMPLES

A solar powered system was designed and constructed at Battelle Memorial Institute in West Jefferson, Ohio, USA and Twentynine Palms, Calif., USA. Tests were conducted using a water/ethylene glycol solution with an initial concentration between 20-30% ethylene glycol.

### 1. Materials and Methods

### 1.1 Location and System Design

The construction of the system was completed at Battelle's West Jefferson, Ohio Facility. This location offered moderate to good sunlight throughout the day.

Schematics of the ethylene glycol concentrator unit are shown in FIG. 1. The system was equipped with a 40 gallon GE Smart Water Heater (distillation chamber) and two Solar Thermal Collector Panels (SPP-30A) that use evacuated tube technology to transfer heat to the test solution. The test solution is pumped from the distillation chamber through ¾″ copper tubing and/or hose where it is further directed through the manifolds on top of the solar collector racks. Once through the manifolds, the solution is directed back to the distillation chamber and is recycled through the system again. The arrows displayed in FIG. 1 indicate the flow of solution through the system. Two temperature gauges are on the ethylene glycol distillation concentrator unit to measure the temperature of the solution as it flows through system. The first is located right before the first solar panel and the second gauge is located after the second solar panel. The distillation chamber has four ¾″ openings in the top of the tank; one that serves as a port for influent returning from the heating racks, two to allow steam to escape for distillation/concentration purposes and one for various processes during tests.

Two valves that can be opened to allow solution to exit the system are shown in FIG. 1. The first valve is located just before the first temperature gauge and is intended to help drain the system of solution once the test is complete. The second valve is located off of the return line copper tubing as soon as the solution begins to be redirected toward the distillation chamber. The second valve helps drain the system, but it is also used as a sampling port to determine ethylene glycol concentration.

### 1.2 Materials

In order to construct the ethylene glycol concentration unit described in Section 2.1, the materials and equipment can be obtained from commercial sources.

### 1.3 Testing Procedures

Once the system in FIG. 1 was constructed, the system was checked for leaks by running tap water through the concentrator unit. A garden hose was used to fill the distillation chamber with water through the small opening in the top of the tank. The pump was turned on and the water was cycled through the system for several hours.

With the integrity of the system in place, an ethylene glycol solution was tested. 7.5 gallons of Prestone® Conventional Green Antifreeze and Coolant was mixed with approximately 30.3 gallons of water in a 55 gallon steel drum to create ˜20% ethylene glycol solution. The ethylene glycol freeze point was measured using a Viper Model portable refractometer. An UtiliTech 1/6 HP submersible pump with a garden hose was used to pump the solution from the 55 gallon drum into the empty distillation chamber. The system pump was turned on and the ethylene glycol solution began cycling through the system. The temperature readings were recorded.

### 2. Results and Discussion

2.1 Solar Power Concentrator Unit Test with Ethylene Glycol and Water

Eight apparatus test configurations were evaluated during the testing period. The results from these tests can be found in Table 1.

TABLE 1

| | | | | | | Final | | |
|---|---|---|---|---|---|---|---|---|
| | | | Starting | Starting | Volume | Remaining | Percent | Water |
| | | Test | Solution | Water | of Water | Water | Water | Removal |
| | | Duration | Volume | Volume | Removed | Volume | Removed | Rate |
| Test # | Date | (hrs) | (L) | (L) | (L) | (L) | (%) | (L/hr) |
| 1 | Jun. 27, 2012 | 33.5 | 27.5 | 18.9 | 21.3 | −2.4 | 112.7 | 0.6 |
| 2 | Jul. 9, 2012 | 41.0 | 39.5 | 30.5 | 17.6 | 12.9 | 57.7 | 0.4 |
| 3 | Jul. 16, 2012 | 23.0 | 39.5 | 30.5 | 6.5 | 24.0 | 21.3 | 0.3 |
| 4 | Jul. 21, 2012 | 48.5 | 39.5 | 30.2 | 14.5 | 15.7 | 48.0 | 0.3 |
| 5 | Jul. 28, 2012 | 59.0 | 39.5 | 30.2 | 29.1 | 1.1 | 96.4 | 0.5 |
| 6 | Aug. 6, 2012 | 25.0 | 39.5 | 30.2 | 16.9 | 13.3 | 56.0 | 0.7 |
| 7 | Aug. 15, 2012 | 15.0 | 15.0 | 11.5 | 8.0 | 3.5 | 69.6 | 0.5 |
| 8 | Aug. 20, 2012 | 8.5 | 15.0 | 11.5 | 3.8 | 7.7 | 33.0 | 0.4 |

% = percent;
hr = hours;
L = liters

### 3. Materials and Methods (Second Embodiment)

### 3.1 Location and System Design

The construction of the system was completed at Battelle's West Jefferson, Ohio Facility. This location offered moderate to good sunlight throughout the day.

Schematics of the ethylene glycol concentrator unit are shown in FIG. 1. The system was equipped with a 46.5 gallon Whirlpool Lowboy Water Heater (distillation chamber) and four Solar Thermal Collector Panels (SPP-30A) that use evacuated tube technology to transfer heat to the test solution. The test solution is pumped from the distillation chamber through ¾″ copper tubing and/or hose where it is further directed through the manifolds on top of the solar collector racks. Once through the manifolds, the solution is directed back to the distillation chamber and is recycled through the system again. The arrows displayed in FIG. 1 indicate the flow of solution through the system. Three temperature gauges are on the ethylene glycol distillation concentrator unit to measure the temperature of the solution as it flows through system. The first is located right after the last solar panel, the second gauge is located inside the distillation chamber and the third is before the first solar panel. The distillation chamber has four ¾″ openings in the top of the tank; one that serves as a port for influent returning from the heating racks, two to allow steam to escape for distillation/concentration purposes and one for various processes during tests.

Two valves that can be opened to allow solution to exit the system are shown in FIG. 1. The first valve is located just before the first solar panel and is intended to help drain the system of solution once the test is complete. The second valve is located off of the return line copper tubing as soon as the solution begins to be redirected toward the distillation chamber. The second valve helps drain the system, but it is also used as a sampling port to determine ethylene glycol concentration.

### 3.2 Materials

In order to construct the ethylene glycol concentration unit described in Section 3.1, the materials and equipment can be obtained from commercial sources.

### 3.3 Testing Procedures

Once the system in was constructed, the system was checked for leaks by running tap water through the concentrator unit. A garden hose was used to fill the distillation chamber with water through the small opening in the top of the tank. The pump was turned on and the water was cycled through the system for several hours.

With the integrity of the system in place, an ethylene glycol solution was tested. 6 gallons of Prestone® Conventional Green Antifreeze and Coolant was mixed with approximately 24 gallons of water in a 55 gallon plastic drum to create ˜20% ethylene glycol solution. The ethylene glycol freeze point was measured using a Viper Model portable refractometer. An UtiliTech ⅙ HP submersible pump with a garden hose was used to pump the solution from the 55 gallon drum into the empty distillation chamber. The system pump was turned on and the ethylene glycol solution began cycling through the system. The temperature readings were recorded. During some testing, the temperatures were recording with data loggers.

### Results and Discussion

Solar Power Concentrator Unit Test with Ethylene Glycol and Water

Twenty apparatus test configurations were evaluated during the testing period. The results are shown in Table 2.

TABLE 2

| | | | | | | Final | | |
|---|---|---|---|---|---|---|---|---|
| | | | Starting | Starting | Volume | Remaining | | |
| | | Test | Solution | Water | of Water | Water | Percent | Removal |
| | | Duration | Volume | Volume | Removed | Volume | Removed | Rate |
| Test # | Date | (hrs) | (L) | (L) | (L) | (L) | (%) | (L/hr) |
| 1.0 | Jul. 24, 2013 | 4.3 | 113.6 | 90.8 | 7.0 | 83.8 | 7.7% | 1.6 |
| 2.0 | Jul. 25, 2013 | 6.9 | 113.6 | 90.8 | 25.8 | 65.0 | 28.4% | 3.7 |
| 3.0 | Jul. 29, 2013 | 7.8 | 113.6 | 90.8 | 15.0 | 75.8 | 16.5% | 1.9 |
| 4.0 | Jul. 30, 2013 | 6.8 | 113.6 | 90.8 | 19.0 | 71.8 | 20.9% | 2.8 |
| 5.0 | Aug. 2, 2013 | 3.9 | 113.6 | 90.8 | 2.0 | 88.8 | 2.2% | 0.5 |
| 6.0 | Aug. 5, 2013 | 8.1 | 113.6 | 90.8 | 19.3 | 71.5 | 21.2% | 2.4 |
| 7.0 | Aug. 12, 2013 | 9.0 | 113.6 | 90.8 | 22.5 | 68.3 | 24.8% | 2.5 |
| 8.0 | Aug. 13, 2013 | 8.6 | 113.6 | 90.8 | 18.5 | 72.3 | 20.4% | 2.2 |
| 9.0 | Aug. 14, 2013 | 8.4 | 113.6 | 90.8 | 19.0 | 71.8 | 20.9% | 2.3 |
| 10.0 | Aug. 15, 2013 | 9.8 | 94.6 | 71.9 | 29.0 | 42.9 | 40.3% | 3.0 |
| 11.0 | Aug. 23, 2013 | 8.8 | 113.6 | 90.8 | 29.5 | 61.3 | 32.5% | 3.3 |
| 12.0 | Aug. 26, 2013 | 7.5 | 113.6 | 90.8 | 10.0 | 80.8 | 11.0% | 1.3 |
| 13.0 | Aug. 30, 2013 | 8.2 | 113.6 | 90.8 | 17.3 | 73.5 | 19.0% | 2.1 |
| 14.0 | Sep. 6, 2013 | 5.3 | 113.6 | 90.8 | 16.0 | 74.8 | 17.6% | 3.0 |
| 15.0 | Sep. 17, 2013 | 6.9 | 113.6 | 90.8 | 13.7 | 77.1 | 15.1% | 2.0 |
| 16.0 | Sep. 18, 2013 | 3.9 | 100.3 | 77.6 | 12.8 | 64.8 | 16.5% | 3.3 |
| 17.0 | Sep. 20, 2013 | 6.9 | 87.0 | 64.3 | 6.0 | 58.3 | 9.3% | 0.9 |
| 18.0 | Sep. 23, 2013 | 9.0 | 81.4 | 58.7 | 21.5 | 37.2 | 36.7% | 2.4 |
| 19.0 | Sep. 24, 2013 | 7.8 | 132.3 | 97.9 | 28.2 | 69.7 | 28.8% | 3.6 |
| 20.0 | Sep. 26, 2013 | 3.9 | 104.0 | 69.7 | NR | NR | NA | NA |

% = percent;
hr = hours;
L = liters

### Materials and Methods (Third Test)

### 3.2 Location and System Design

The construction of the system was completed at Marine Corps Air Ground Combat Center, Twentynine Palms, Calif.. This location offered good to excellent sunlight throughout the day. Schematics of the ethylene glycol concentrator unit are shown in FIG. 1. The system was equipped with a 46.5 gallon Whirlpool Lowboy Water Heater (distillation chamber) and three Solar Thermal Collector Panels (SPP-30A) that use evacuated tube technology to transfer heat to the test solution. The test solution is thermo siphoned from the distillation chamber through ¾″ copper tubing and/or hose where it is further directed through the manifolds on top of the solar collector racks. Once through the manifolds, the solution is converted to steam and directed back to the distillation chamber. Any steam that does not escape the distillation chamber is recycled through the system again. The arrows displayed in FIG. 1 indicate the flow of solution through the system. Temperature gauges on the ethylene glycol distillation concentrator unit measure the temperature of the solution as it flows through system. The placement of the temperature gauges can vary and for this setup were located as follows: one at the bottom of the distillation chamber(s). The distillation chamber has four ¾″ openings in the top of the tank; one that serves as a port for influent returning from the heating racks, two to allow steam to escape for distillation/concentration purposes and one for various processes during tests.

Two valves that can be opened to allow solution to exit the system are shown in FIG. 1. The first valve is located just before the first solar panel and is intended to help drain the system of solution once the test is complete. The second valve is located off of the return line copper tubing as soon as the solution begins to be redirected toward the distillation chamber. The second valve helps drain the system, but it is also used as a sampling port to determine ethylene glycol concentration.

### 5.2 Materials

In order to construct the ethylene glycol concentration unit described in Section 5.1, the materials and equipment can be obtained from commercial sources.

### 5.3 Testing Procedures

Once the system was constructed, the system was checked for leaks by running tap water through the concentrator unit. A garden hose was used to fill the distillation chamber with water through the small opening in the top of the tank. The pump was turned on and the water was cycled through the system for several hours.

With the integrity of the system in place, an ethylene glycol solution was tested. Approximately 40.0 gallons of 25% glycol solution was added to the distillation chamber. The solution had a freeze point of approximately 9° F. as measured by a Viper Model portable refractometer. An UtiliTech ⅙ HP submersible pump with a garden hose was used to pump the solution from the 55 gallon drum into the empty distillation chamber. The system pump was turned on and the ethylene glycol solution began cycling through the system. The circulation pump was turned off at the end of the testing day. On the second day of testing, the circulation pump was left off and thermo siphoning was tested. The temperature readings were recorded periodically throughout testing.

### Results and Discussion

Two apparatus test configurations were evaluated during the testing period. The results from these tests can be found in Table 3. The first test was with non-assisted venting, 1 hot water tank, 2¾ inch pop-up valves and 1¾ inch gate valve on the hot water tank 1 (the gate valve was closed during heat up). The first test used a pump for circulating fluid. The second test used the same set-up except that there was no pump circulating fluid and used only thermosiphoning. There were two other differences between the first and second test: the solar arrays were washed in between tests and the second test utilized solution that had been heated in the previous days testing. It is believed, however, that the washing or preheating do not account for the substantial difference between the results of day 1 and day 2 testing. It is believed that the majority of the surprisingly improved results in day 2 testing was due to the use of thermosiphoning in place of pumping.

TABLE 3

| | | | | | | Final | | |
|---|---|---|---|---|---|---|---|---|
| | | | Starting | Starting | Volume | Remaining | Percent | Water |
| | | Test | Solution | Water | of Water | Water | Water | Removal |
| | | Duration | Volume | Volume | Removed | Volume | Removed | Rate |
| Test # | Date | (hrs) | (L) | (L) | (L) | (L) | (%) | (L/hr) |
| 1 | Feb. 12, 2014 | 9.3 | 151.4 | 113.6 | 6.0 | 107.6 | 5.3% | 0.6 |
| 2 | Feb. 13, 2014 | 9.8 | 145.4 | 109.1 | 20.0 | 89.1 | 18.3% | 2.1 |

% = percent;
hr = hours;
L = liters

1. A method of separating components in a solar-powered unit, comprising:
providing a solar-powered distillation unit comprising: a storage chamber, a solar thermal collector array, and piping that forms a circuit from the storage chamber past and in thermal contact with the solar thermal collector array, and back to the storage chamber;
providing to the storage chamber a liquid solution comprising a first component and a second component wherein the first component has a boiling point that is lower than the boiling point of the second component;
wherein the solar thermal collector array collects heats from the sun;
wherein a portion of the liquid solution passes from the storage chamber through the piping past and in thermal contact with the solar thermal collector array;
wherein heat is transferred from the solar thermal collector array to the liquid solution to form a heated solution;
wherein a vapor is formed from the heated solution; and
wherein at least a portion of the vapor passes out of the circuit;
wherein liquid from the heated solution is returned to the storage chamber; and
wherein the vapor that passes out of the circuit has a higher ratio of the first component to the second component than the liquid that remains in the storage chamber.

2. The method of claim 1 wherein the first component is water and the second component is ethylene glycol.

3. The method of claim 1 wherein the distillation chamber further comprises a heat exchanger in thermal contact with the liquid solution and wherein a portion of the heat from the liquid solution is used is preheat a solution in a preheat chamber to form a heated solution.

4. The method of claim 3 wherein the heated solution is added to the storage chamber prior to the step of at least a portion of the vapor passing out of the circuit, wherein the storage chamber is a distillation chamber from which the lower boiling component is preferentially distilled out.

5. The method of claim 1 wherein thermal siphoning causes the portion of the liquid solution to flow through the piping.

6. The method of claim 5 wherein pumping is not used to force solution through the circuit.

7. The method of claim 1 further comprising a condenser disposed in the circuit between between the solar array and the storage chamber wherein liquid forms in the condenser and the liquid formed in the condenser is returned to the storage chamber.

8. The method of claim 4 wherein the distillation chamber further comprises a spray nozzle that sprays a solution comprising the first and second components.

9. The method of claim 3 wherein the circuit comprises a series of solar thermal arrays.

10. The method of claim 9 wherein there is at least one pump disposed between the distillation chamber and the series of solar thermal collector arrays, and wherein sufficient heat is transferred to the liquid solution to raise the temperature of the solution to the boiling point of at least one component of the solution.

11. The method of claim 10 wherein the distillation chamber is fitted with two pressure relief valves, and has four openings in the top of the tank; one that serves as a port for influent returning from the n-solar thermal collector panels, two to allow steam to escape for evaporation purposes and one for filling chamber with more solution when needed.

12. The method of claim 10 wherein the distillation chamber is fitted with two pressure relief valves, and has four openings in the top of the tank; one that serves as a port for influent returning from the solar thermal arrays, two to allow steam to escape for evaporation purposes and one for filling chamber with more solution, and wherein vacuum is applied to the two openings for the steam.

13. The method of claim 1 wherein a valve is located before the first solar thermal collector array to allow draining of the system.

14. The method of claim 1 wherein the temperature of the solution is raised at a rate of at least 1.0 degrees Fahrenheit per minute.

15. The method of claim 10 wherein a reservoir containing recycled ethylene glycol from a waste stream at a concentration of less than 37% is periodically transferred to the distillation chamber.

16. The method of claim 10 wherein the pump can pump at variable rates.

17. The method of claim 1 wherein the solar thermal collector array is mounted on a solar tracking device.

18. A kit comprising:
a distillation chamber, a solar thermal collector array, and piping;
wherein the distillation chamber, the solar thermal collector array, the piping are adapted to form a circuit from the distillation chamber past and in thermal contact with the solar thermal collector array, and back to the distillation chamber.

19. The kit of claim 7 further comprising a preheat chamber and a heat exchanger that are adapted to transfer heat from a liquid solution in the distillation chamber to a liquid in the preheat chamber.

20. The kit of claim 7 sized for transportation on a single truck.
